(19) United States
(12) Patent Application Publication
(10) Pub. No.: US 2017/0142954 A1
(43) Pub. Date: May 25, 2017

(54) GLUE TRAP APPARATUS

(71) Applicant: LEONARD ROLA, BEACON, NY (US)

(72) Inventor: LEONARD ROLA, BEACON, NY (US)

(21) Appl. No.: 15/402,485

(22) Filed: Jan. 10, 2017

Related U.S. Application Data
(63) Continuation-in-part of application No. 15/007,516, filed on Jan. 27, 2016, now abandoned.
(60) Provisional application No. 62/130,010, filed on Mar. 9, 2015.

(51) Int. Cl. A01M 1/14; A01M 1/10

(52) U.S. Cl. CPC A01M 1/14; A01M 1/103

(57) ABSTRACT

A pest control device is provided for trapping for example bugs. The device comprises a solid body and an adhesive layer over the solid body to trap bugs that try to access a furniture post. In some embodiments, a central opening in the adhesive exposes the furniture post to a non-sticky portion of the solid body. Some embodiments include a plurality of sheets of adhesive material that include an enlarged area with a central opening therethrough. The central opening is adapted to receive a furniture post therethrough while the enlarged area of the solid body surrounds the post along the floor or other surface preventing access from underneath the device. The device includes a stack of removable adhesive sheets. A used sheet can be peeled off to reveal a clean sheet thereunder.

### CROSS-REFERENCE TO RELATED APPLICATION

This application claims benefit under 35 U.S.C. §119(e) of U.S. Provisional Application having Ser. No. 62/130,010 filed Mar. 9, 2015, and U.S. non-provisional application Ser. No. 15/007,516 filed Jan. 27, 2016, which are hereby incorporated by reference herein in its entirety

### FIELD

The subject disclosure relates to pest control, and more particularly, to a glue apparatus for trapping pests.

### BACKGROUND

Pests are well known for overwhelming one's habitat or business with infestation once left unchecked. Moreover, some pests are notorious for hiding in and inhabiting articles which are used daily by the person. The pests access for example, one's furniture such as beds or couches and hide in crevices making detection difficult.

For example, bed bugs are very difficult to get rid of because they are hard to find and kill. During the nighttime, bed bugs come out from hiding and bite people as they sleep. Bed bugs may also migrate climbing up structures, for example, furniture posts touching the floor, into other places to nest such as one's clothing storage, taking up residence in one's clothes. Unwittingly, one may then carry one or more of the pests to another locale spreading the nuisance thereto.

Some methods of removal include spray pesticides or bug bombs, but unfortunately pesticides of this type may not be completely effective since the spray may not reach areas in which the bug hides and can be dangerous if used improperly.

Devices exist in the art related to insect traps and glue traps. These include those with a confinement area in which a replaceable glue pad is positioned. Others provide a glue trap formed as an enclosed paperboard receptacle with adhesive on the walls thereof. Prior art devices are generally placed adjacent a floor/wall interface anticipating pests will travel along the perimeter edges of a room. Devices as described above are easily circumvented and are especially avoided when placed near furniture posts.

As can be seen, there is a need for a device that can trap pests as they attempt to climb up furniture posts.

### SUMMARY

In one aspect of the disclosure, a glue trap comprises a sheet including a layer of adhesive on an upper surface of the sheet for trapping pests coming into contact with the adhesive. A central opening in the sheet is adapted to receive a furniture post within the central opening. Pests will be trapped as they attempt to access the furniture post.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a front view of a glue trap system in packaging in accordance with an aspect of the subject technology.

FIG. 2 is a perspective top view of a glue trap in use around the base of a furniture post in accordance with an aspect of the subject technology.

FIG. 3 is a perspective top view of the glue trap of FIG. 3 showing a used top sheet peeled away from underlying sheets.

FIG. 4 a perspective view of the glue trap of FIG. 2 in use around the base of multiple pieces of furniture.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, exemplary embodiments of the subject technology provide a pest control device for capturing and killing insects attempting to crawl up furniture. Specifically, a solid body platform incorporating a glue trap element is disclosed that prevents access to posts from underneath the platform and traps bugs as they attempt to access the upright posts of furniture.

Overall, the present invention is effective for preventing bugs from reaching furniture by capturing bugs as they attempt to gain access to furniture items. This is useful for indoor and outdoor furniture, as well as for treating bedbugs around bedposts. The disclosed barrier glue trap eliminates the need for harsh bug repellants and dangerous chemicals. The device includes solid body onto which the furniture post rests and a sticky area surrounding a central area adapted to accommodate the post of a furniture article. In some embodiments, the solid body includes adhesive layers of the sticky area with central opening. Over time, the user peels away adhesive layers to reveal a fresh layer when needed.

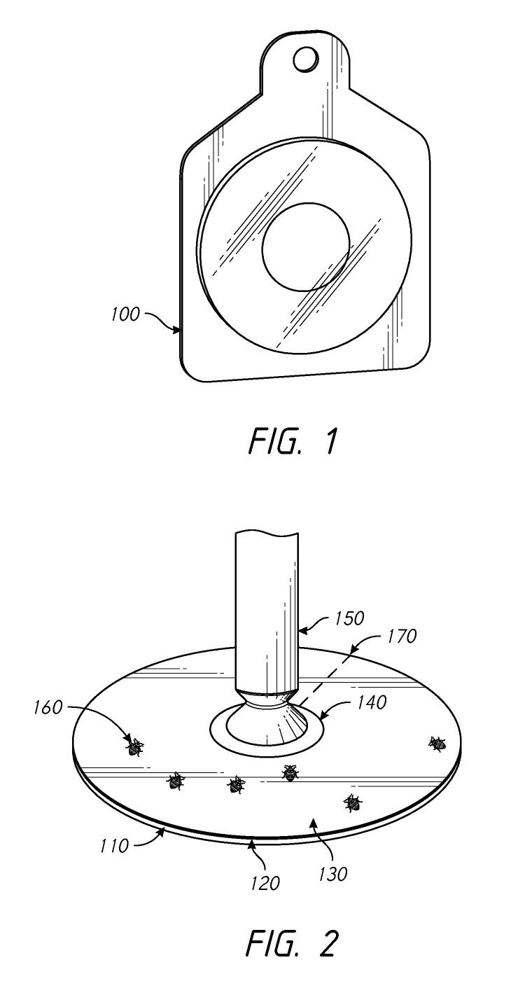

Referring now to FIGS. 1 and 2, there is shown an exemplary embodiment of a pest control device in its packaging 100 and in use. The pest control device may include a solid body 110 and a sheet 130. The sheet 130 rests atop the solid body 110. The solid body may be for example, a plate with a relatively flat underside so that when a furniture posts rests on top of the solid body 110, the solid body 110 is pressed flat down on the floor thus preventing access to the post from underneath the solid body 110. In some embodiments, the solid body 110 may be a caster so that furniture may be conveniently moved around a floor without exposing the furniture posts to bugs during movement. The thickness of the solid body 110 may be approximately 1/8″ providing an initial barrier. The sheet 130 includes an area of glue or adhesive 120 surrounding a central opening 140 of the solid body 110, which has no sticky substance. The area of glue or adhesive 120 may be approximately five inches in diameter. The central opening 140 is adapted to surround a furniture post 150 resting on the floor. For example, the central opening 140 may be approximately 3 inches in diameter. The central opening 140 provides an open area for the furniture post 150 to rest on (supported by) the solid body 110 so that the post 150 is not necessarily exposed to any glue or adhesive. Yet the furniture post 150 is also elevated from the underlying floor. As will be appreciated, the furniture post 150 is protected from access by bugs because the solid body 110 creates a solid barrier preventing bugs from climbing up the post 150 from below. As bugs attempt to crawl over the solid body 110, they encounter the area of glue or adhesive 120 trapping them before they can traverse the top of the device and reach the furniture post 150. In an exemplary embodiment, the sheet 130 may be disc-shaped or circular and sized to be larger than a majority of pests 160 (for example, insects). The distance from an outer edge of the sheet 130 to the edge of the central opening 140 may be approximately two inches. Thus, a pest 160 would need to contact the layer 120 in order to reach the furniture post 150. In operation, as a pest 160 would travel over the exposed surface of the sheet 130 getting caught by the layer 120.

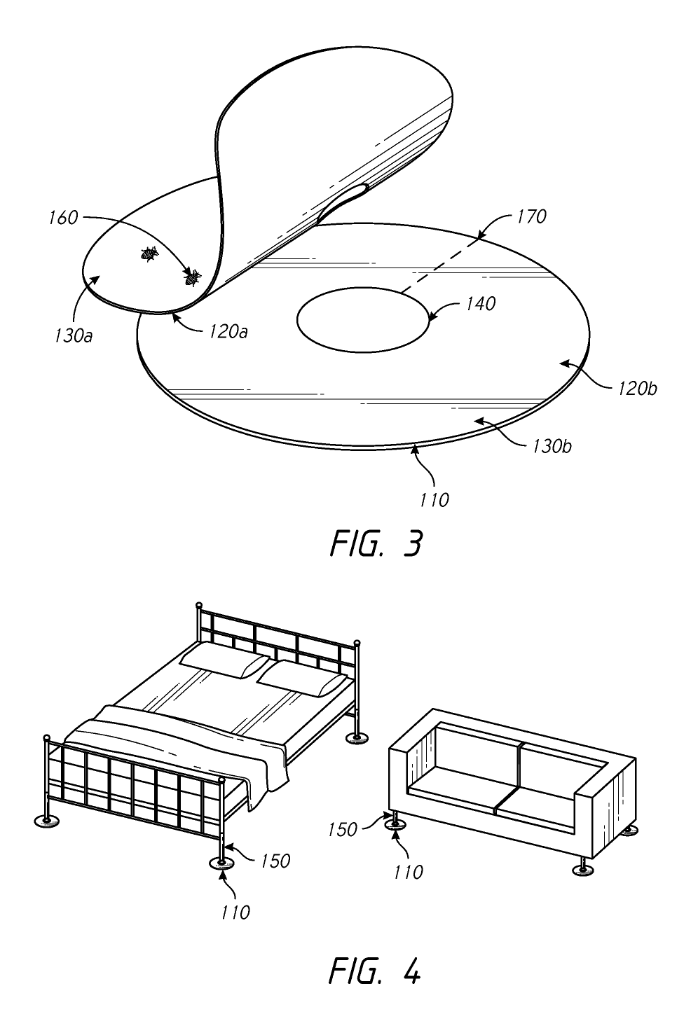

Referring now to FIGS. 2 and 3, an exemplary embodiment of the pest control device comprises a plurality of sheets 130 (sheets 130a and 130b) with respective adhesive surface layers 120a and 120b stacked on one another. The adhesive on surface layers 120a and 120b may be of sufficient adhesion to immobilize pests 150 such as insects and yet be tacky enough to allow the sheet 130a to be separated from the sheet 130b by manual force from a user. The central opening 140 may extend through the stack of sheets 130 exposing the non-sticky surface of the solid body 110 therein. Each sheet 130 is removable from the next by peeling away the topmost sheet 130. Some embodiments may include a series of perforations or a slit 170 extending from the central opening 140 to an outer edge of the sheet 130. In some embodiments, the stack of peelable sheets 130 may be refreshed (available as a supplemental stack sold separately from the solid body 110) and placed onto a solid body 110 whose sheets 130 have been used.

As shown in FIG. 3, once pests 160 are trapped by layer 120a, the exposed sheet 130a is peeled away from sheet 130b and the solid body 110 exposing a fresh unused surface layer 120b for trapping additional pests 160. In this way, the furniture post 150 is positioned through the central opening 140 and the adhesive is disposed around its periphery on the solid body 110. As bugs attempt to gain access to the furniture post, the adhesive traps the bugs on the surface, preventing their access to the furniture item.

Each sheet 130 may adhere to the underlying sheet 130 by the adhesive layer 120 until peeled away, thereby allowing the upper adhesive layer 120 to remain tacky after periods of time. The upper adhesive layer 120 may become filled with pests 160 or simply lose tackiness after a period of dust accumulation. Therefore, each sheet 130 is peelable to reveal a fresh layer 120 of adhesive for extended use of one pest control device around the furniture post 150. The user may tear the used sheet 130a along the series of perforations 170 and pull the sheet 130a from around the furniture post 150 without the need to lift furniture. In addition, the pest control device may be moved with the article of furniture across flooring as the solid body 110 provides a caster function maintaining pest control features as the furniture is moved.

Referring now to FIG. 4, the solid body 110 of the pest control device may be positioned under multiple furniture posts 150 for multiple pieces of furniture. The pest control device disclosed is suitable for indoor and outdoor use, and may be primarily designed for use in conjunction with bedposts and other furniture posts 150. The central opening 140 is a position upon which furniture posts 150 and other furniture legs can be placed through onto the solid body 110. As bugs and other pests 160 swarm the furniture and try to climb up the posts 150, they will stick to the exposed adhesive on layer 120 and eventually die. Users can peel away the top sheet 130 as needed to reveal a fresh, clean layer beneath it, thus providing a system protecting each piece of furniture from being infested by the most easily accessible path; the floor. As may be appreciated, the pest control device is easy to position, provides a low profile under furniture, and is easy to maintain with its peelable sheets 130 that are quickly replaced on convenience.

Those of skill in the art would appreciate that various components and blocks may be arranged differently (e.g., arranged in a different order, or partitioned in a different way) all without departing from the scope of the subject technology.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A pest control device, comprising:
a solid plate body;
a layer of adhesive on an upper surface of the solid plate body; and
a central opening in the layer of adhesive, positioned to expose the solid body through the layer of adhesive, the central opening adapted to receive a furniture post supported by the solid body.

2. The pest control device of claim 1, wherein the furniture post is supported by the solid body without exposing the furniture post to adhesive.

3. The pest control device of claim 1, further comprising a plurality of sheets including the layer of adhesive, the plurality of sheets arranged in a stack of sheets, and
wherein the adhesive comprises a tackiness that is strong enough to hold adjacent sheets in the stack of sheets together and separable by manual force.

4. The pest control device of claim 3, wherein the central opening extends through the stack of sheets exposing the furniture post to the underlying solid body.

5. The pest control device of claim 1, further comprising a series of perforations or a slit extending from the central opening to an outer edge of the sheet.

6. The pest control device of claim 1, wherein the solid body is a furniture caster.

7. The pest control device of claim 1, wherein the solid body includes a thickness of approximately 1/8″.

8. The pest control device of claim 7, further comprising an area of adhesive of the adhesive layer is approximately 5″ in diameter and an area of the central opening is approximately 3″ in diameter.
